(19) United States
(12) Patent Application Publication
(10) Pub. No.: US 2026/0008924 A1
(43) Pub. Date: Jan. 8, 2026

(54) COMPOSITION AND DISPLAY APPARATUS INCLUDING CURED PRODUCT OF THE COMPOSITION

(71) Applicant: Samsung Display Co., Ltd., Yongin-si (KR)

(72) Inventors: Hyunseok Oh, Yongin-si (KR); Seungho Kim, Yongin-si (KR); Seungwon Kuk, Yongin-si (KR); Sunghyun Kim, Yongin-si (KR); Kangwoo Lee, Yongin-si (KR)

(21) Appl. No.: 19/022,986

(22) Filed: Jan. 15, 2025

(30) Foreign Application Priority Data
Jul. 3, 2024 (KR) 10-2024-0087802

(51) Int. Cl. C09D 4/00; C08G 18/67; C08G 18/72; C08K 3/04; C08K 3/22; C08K 3/26; C09D 5/04; C09D 7/61; C09D 175/04

(52) U.S. Cl. CPC C09D 4/00; C08G 18/672; C08G 18/722; C08K 3/04; C08K 3/22; C09D 5/04; C09D 7/61; C09D 175/04; C08G 2150/00; C08K 2003/2227; C08K 2003/2241; C08K 2003/265

(57) ABSTRACT

A composition including a first monomer, a second monomer, a third monomer, and a light-shielding material, and a display apparatus including a cured product of the composition are provided, wherein a free volume radius of the cured product of the composition is 3.00 Å or less and a fractional free volume of the cured product of the composition is 2.50% or less.

### CROSS-REFERENCE TO RELATED APPLICATION

The present application claims priority to and the benefit of Korean Patent Application No. 10-2024-0087802, filed on Jul. 3, 2024, in the Korean Intellectual Property Office, the entire disclosure of which is incorporated herein by reference.

### BACKGROUND

### 1. Field

One or more embodiments of the present disclosure relate to a composition and a display apparatus including a cured product of the composition.

### 2. Description of the Related Art

Electronic devices, including smart phones, digital cameras, laptop computers, navigation systems, and/or smart televisions, utilize one or more display apparatuses to present images to users. These display apparatuses include a display panel that generates and displays images, and a cover window positioned on the display panel to protect it.

To prevent or reduce light leakage from the display panel, a composition is applied onto sides of the display panel and cured to form a barrier layer. This barrier layer is desired or essential for preventing or reducing light leakage. Therefore, the development of a composition with (having) characteristics suitable for forming such a barrier layer is desired or necessary to manufacture a high-quality display apparatus.

### SUMMARY

One or more aspects of embodiments of the present disclosure are directed toward a composition suitable for forming a barrier layer arranged on a side of a display panel and with (having) a barrier function (to protect) against external substances such as chemicals, and a display apparatus that includes a cured product of the composition.

Additional aspects will be set forth in part in the description which follows and, in part, will be apparent from the description, or may be learned by practice of the presented embodiments of the disclosure.

According to one or more embodiments of the present disclosure, a composition includes:
a first monomer; a second monomer; a third monomer; and a light-shielding material,
wherein the first monomer includes at least one of an isocyanate monomer, an acrylate monomer, or a siloxane monomer,
the second monomer includes at least one of an acrylate monomer or an amide monomer,
the third monomer includes a monomer having three or more functional groups,
the first monomer, the second monomer, the third monomer, and the light-shielding material are different from one another,
a free volume radius of a cured product of the composition is 3.00 Angstroms (Å) or less, and
a fractional free volume of the cured product of the composition is 2.50% or less.

According to one or more embodiments of the present disclosure, a display apparatus includes:
a display panel including a light-emitting device; and
a barrier layer in contact with a side of the display panel,
wherein the barrier layer includes a cured product of the composition.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the disclosure will be more apparent from the following description taken in conjunction with the accompanying drawings, in which:

FIG. 1 is a cross-sectional view schematically illustrating a laminated structure of a display apparatus according to one or more embodiments of the present disclosure;

FIG. 2 is a cross-sectional view schematically illustrating a laminated structure of a display apparatus according to one or more embodiments of the present disclosure; and

FIG. 3 shows the results of evaluating the barrier properties of a barrier layer formed by using a composition according to one or more embodiments of the present disclosure.

### DETAILED DESCRIPTION

Reference will now be made in more detail to one or more embodiments, examples of which are illustrated in the accompanying drawings, wherein like reference numerals refer to like elements throughout the present disclosure, and duplicative descriptions thereof may not be provided for conciseness. In this regard, the presented embodiments may have different forms and should not be construed as being limited to the descriptions set forth herein. Accordingly, embodiments of the present disclosure are merely described, by referring to the drawings, to explain aspects of the present disclosure. As used herein, the term “and/or” or “or” may include any and all combinations of one or more of the associated listed items. Throughout the disclosure, the expressions such as “at least one of,” “one of,” and “selected from,” when preceding a list of elements, modify the entire list of elements and do not modify the individual elements of the list. For example, “at least one of a, b, or c,” “at least one selected from a, b, and c,” “at least one selected from among a to c,” etc., may indicates only a, only b, only c, both (e.g., simultaneously) a and b, both (e.g., simultaneously) a and c, both (e.g., simultaneously) b and c, all of a, b, and c, or variations thereof.

Because the disclosure may have diverse modified embodiments, example embodiments are illustrated in the drawings and are described in the detailed description. An effect and a characteristic of the disclosure, and a method of accomplishing these will be apparent if (e.g., when) referring to one or more embodiments described with reference to the drawings. The disclosure may, however, be embodied in many different forms and should not be construed as limited to one or more embodiments set forth herein.

It will be understood that although the terms “first,” “second,” and/or the like used herein may be used herein to describe one or more suitable components, these components should not be limited by these terms. These terms are only used to distinguish one component from another.

As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure.

It will be further understood that the terms “comprise(s)/comprising,” “include(s)/including,” or “has (have)/having” used herein specify the presence of stated features or components, but do not preclude the presence or addition of one or more other features or components. Unless defined otherwise, the terms “comprise(s)/comprising,” “include(s)/including,” or “has (have)/having” may refer to both (e.g., simultaneously) the case of consisting of features or components described in the disclosure and the case of further including other components.

It will be understood that if (e.g., when) a layer, region, or component is referred to as being “on” or “onto” another layer, region, or component in the disclosure, it may be directly or indirectly formed on the other layer, region, or component. For example, for example, one or more intervening layers, regions, or components may be present therebetween. In contrast, if (e.g., when) an element is referred to as being “directly on” another element, there are no intervening element present therebetween.

The term “A and/or B” as used herein indicates A, B, or both (e.g., simultaneously) A and B. In the context of the present application and unless otherwise defined, the terms “use,” “using,” and “used” may be considered synonymous with the terms “utilize,” “utilizing,” and “utilized,” respectively.

### Composition

According to one or more embodiments, a composition may include a first monomer, a second monomer, a third monomer, and a light-shielding material, wherein the first monomer, the second monomer, and the third monomer are different from one another.

The first monomer, the second monomer, the third monomer, and the light-shielding material may be the same as described herein.

According to one or more embodiments, a cured product of the composition may be formed by using UV curing and moisture curing.

According to one or more embodiments, a free volume radius of the cured product of the composition may be 3.00 Å or less, 2.99 Å or less, 2.98 Å or less, 2.97 Å or less, 2.96 Å or less, 2.95 Å or less, 2.94 Å or less, 2.93 Å or less, 2.92 Å or less, 2.91 Å or less, 2.90 Å or less, 2.89 Å or less, 2.88 Å or less, 2.87 Å or less, 2.86 Å or less, or 2.85 Å or less.

According to one or more embodiments, a fractional free volume of the cured product of the composition may be 2.50% or less, 2.40% or less, 2.30% or less, 2.20% or less, 2.10% or less, or 2.00% or less.

Herein, the free volume radius and the fractional free volume may be values each measured by positron annihilation lifetime spectroscopy (PALS). The PALS is a method of measuring a free volume of a polymer by measuring an annihilation lifetime of a specific positron within the polymer. In other words, the PALS is a method of measuring free volume characteristics such as free volume radius and fractional free volume of a polymer by measuring an annihilation lifetime of a specific positron within the polymer.

According to one or more embodiments, an average molecular weight between crosslinks (Mc) value of the cured product of the composition may be 5.024×10⁴ g/mol or less.

Herein, the Mc is a value measured by using dynamic mechanical analysis (DMA). However, the measuring device is not limited to DMA, and for example, a rheometer may be used as the measuring device.

When the composition according to one or more embodiments of the disclosure is cured by using a method such as UV curing or moisture curing, the cured product of the composition may have a free volume radius of 3.00 Å or less and a fractional free volume of 2.50% or less. When these conditions are satisfied, the cured product of the composition may have a barrier function that prevents external substances such as chemicals from passing through.

According to one or more embodiments, a gel fraction value measured for a solvent selected from among acetone, toluene, and butyl acetate, for the cured product of the composition, may be 90.0% or more, 91.0% or more, or 92.0% or more.

Herein, detailed measurement methods of the gel fraction value may be the same as described in Evaluation Example 1.

According to one or more embodiments, a thixotropic index (TI) value of the cured product of the composition may be 1.6 or more.

According to one or more embodiments, if (e.g., when) a thickness of the cured product of the composition is 30 μm, an optical density (OD) value may be 2 or more, 2.1 or more, 2.2 or more, or 2.3 or more for light having a wavelength of about 380 nm to about 760 nm.

According to one or more embodiments, a viscosity of the cured product of the composition may be about 1,000 centipoise (cPs) to about 20,000 cPs at 25° C.

### First Monomer

The first monomer may include at least one of an isocyanate monomer, an acrylate monomer, or a siloxane monomer.

According to one or more embodiments, the first monomer may include an isocyanate monomer.

According to one or more embodiments, the isocyanate monomer may include at least one saturated hydrocarbon ring. For example, in one or more embodiments, the isocyanate monomer may include one or two saturated hydrocarbon rings.

According to one or more embodiments, the saturated hydrocarbon ring may be cyclopentane, cyclohexane, or cycloheptane.

According to one or more embodiments, the first monomer may include a monomer represented by Formula 1-1 or Formula 1-2:

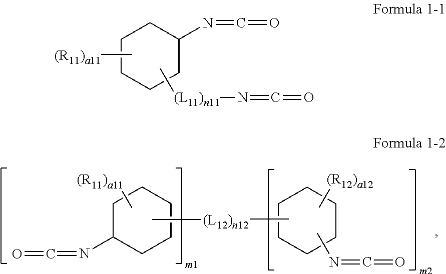

wherein, in Formulae 1-1 and 1-2,
R₁₁ and R₁₂ may each independently be hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a11 and a12 may each independently be an integer from 1 to 10,
L₁₁ and L₁₂ may each independently be a single bond, a C₁-C₆₀ alkylene group unsubstituted or substituted with at least one R₁₀ₐ, a C₂-C₆₀ alkenylene group unsubstituted or substituted with at least one R₁₀ₐ, a C₂-C₆₀ alkynylene group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, or any combination thereof,
n11 and n12 may each independently be an integer from 1 to 5,
m1 and m2 may each independently be an integer from 1 to 3,
R₁₀ₐ may be:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, or a C₆-C₆₀ arylthio group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, a cyano group, a phenyl group, a biphenyl group, a pyridinyl group, a pyrimidinyl group, a pyridazinyl group, a pyrazinyl group, a triazinyl group, or any combination thereof; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

For example, in one or more embodiments, the first monomer may include isophorone diisocyanate, dicyclohexylmethane 4,4′-diisocyanate, or any combination thereof.

According to one or more embodiments, the first monomer may include a first-first monomer and a first-second monomer,
the first-first monomer and the first-second monomer may be different from each other, and
the first-first monomer and the first-second monomer may each include at least one cyclohexane.

According to one or more embodiments, the first-first monomer may include a monomer represented by Formula 1-1, and the first-second monomer may include a monomer represented by Formula 1-2.

According to one or more embodiments, the first monomer may further include a first-third monomer different from the first-first monomer and the first-second monomer.

According to one or more embodiments, the first-third monomer may not include (e.g., may exclude) a saturated hydrocarbon ring.

According to one or more embodiments, the first-third monomer may include a monomer represented by Formula 1-3:

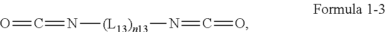

wherein, in Formula 1-3, L₁₃ may be a C₁-C₆₀ alkylene group unsubstituted or substituted with at least one R₁₀ₐ, a C₂-C₆₀ alkenylene group unsubstituted or substituted with at least one R₁₀ₐ, or a C₂-C₆₀ alkynylene group unsubstituted or substituted with at least one R₁₀ₐ, and n13 may be an integer from 1 to 10.

For example, the first-third monomer may include 2,4-toluene diisocyanate, methylene diphenyl diisocyanate, hexamethylene diisocyanate, or any combination thereof.

### Second Monomer

The second monomer may include at least one of an amide monomer or an acrylate monomer. However, the second monomer is not limited thereto, and any monomer including a functional group capable of being bonded to the first monomer may be used.

According to one or more embodiments, the second monomer may include at least one amide monomer and at least one acrylate monomer.

According to one or more embodiments, the second monomer may include a monomer represented by Formula 2:

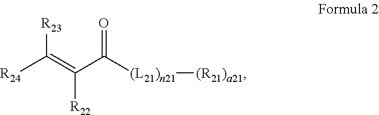

wherein, in Formula 2,
L₂₁ may be a single bond, *—C(R₂ₐ)(R_{2b})—*′, *—C(R₂ₐ)═*′, *—C(R₂ₐ)═C(R_{2b})—*′, *—C(═O)—*′, *—C(═S)—*′, *—C≡C—*′, *—B(R₂ₐ)—*′, *—N(R₂ₐ)—*′, *—O—*′, *—P(R₂ₐ)—*′, *—Si(R₂ₐ)(R_{2b})—*′, *—P(═O)(R₂ₐ)—*′, *—S—*′, *—S(═O)—*′, *—S(═O)₂—*′, or *—Ge(R₂ₐ)(R_{2b})—*′, wherein * and *′ may each be a binding site with a neighboring atom,
R₂₁ to R₂₄, R₂ₐ, and R_{2b} may each independently be hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a21 may be an integer from 1 to 5,
n21 may be an integer from 1 to 3,
R₁₀ₐ may be:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, or a C₆-C₆₀ arylthio group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, a cyano group, a phenyl group, a biphenyl group, a pyridinyl group, a pyrimidinyl group, a pyridazinyl group, a pyrazinyl group, a triazinyl group, or any combination thereof; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

For example, in one or more embodiments, the second monomer may include isobornyl acrylate, acrylic acid, methyl acrylate, ethyl acrylate, isopropyl acrylate, n-butyl (meth) acrylate, isobutyl acrylate, tert-butyl acrylate, n-pentyl acrylate, n-hexyl acrylate, cyclohexyl acrylate, n-heptyl acrylate, n-octyl acrylate, 2-ethylhexyl acrylate, nonyl acrylate, decyl acrylate, 2-isocyanatoethyl acrylate, 2-hydroxyethyl methacrylate, glycol methacrylate, glycol monomethacrylate, ethylene glycol methacrylate, 2-(methacryloyloxy) ethanol, N,N-dimethylacrylamide, 2-hydroxyethylmethacrylate, lauryl acrylate, or any combination thereof.

According to one or more embodiments, the second monomer may include a second-first monomer, a second-second monomer, and a second-third monomer. The second-first monomer, the second-second monomer, and the second-third monomer may be different from one another.

According to one or more embodiments, the second-first monomer, the second-second monomer, and the second-third monomer may each independently include a monomer represented by Formula 2.

According to one or more embodiments, the second-first monomer may include a monomer represented by Formula 2-1:

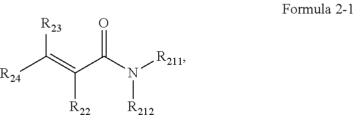

wherein, in Formula 2-1,
R₂₂ to R₂₄ may each be the same as described herein, and
R₂₁₁ and R₂₁₂ may each independently be the same as described with respect to R₂₁.

According to one or more embodiments, the second-second monomer may include a monomer represented by Formula 2-2:

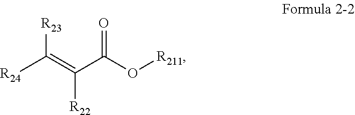

wherein, in Formula 2-2, R₂₂ to R₂₄ may each be the same as described herein, and
R₂₁₁ may be the same as described herein with respect to R₂₁.

For example, in one or more embodiments, the second-second monomer may include a monomer represented by Formula 2-2, and R₂₁₁ in Formula 2-2 may include at least one ring.

According to one or more embodiments, the second-third monomer may include a monomer represented by Formula 2-2.

### Third Monomer

The third monomer may include a monomer having three or more functional groups.

According to one or more embodiments, the functional group may be an alkene group, a hydroxyl group, an ether group, a carbonyl group, a carboxyl group, an ester group, an amide group, or any combination thereof.

According to one or more embodiments, in the monomer having three or more functional groups, a linking group connecting two of the functional groups may have 1 to 5 carbon atoms.

According to one or more embodiments, the third monomer may include an acrylate monomer. However, the third monomer is not limited thereto, and any monomer including a functional group capable of bonding with the first monomer may be used.

According to one or more embodiments, the third monomer may include a monomer represented by Formula 3-1:

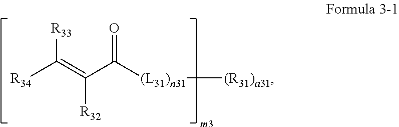

wherein, in Formula 3-1,
L₃₁ may be a single bond, *—C(R₃ₐ)(R_{3b})—*′, *—C(R₃ₐ)═*′, *—C(R₃ₐ)═C(R_{3b})—*′, *—C(═O)—*′, *—C(═S)—*′, *—C≡C—*′, *—B(R₃ₐ)—*′, *—N(R₃ₐ)—*′, *—O—*′, *—P(R₃ₐ)—*′, *—Si(R₃ₐ)(R_{3b})—*′, *—P(═O)(R₃ₐ)—*′, *—S—*′, *—S(═O)—*′, *—S(═O)₂—*′, or *—Ge(R₃ₐ)(R_{3b})—*′, wherein * and *′ may each be a binding site with a neighboring atom,
n31 may be an integer from 1 to 3,
R₃₁ to R₃₄, R₃ₐ, and R_{3b} may each independently be hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a31 may be an integer from 1 to 5,
m3 may be an integer of 3 or 4,
R₁₀ₐ may be:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, or a C₆-C₆₀ arylthio group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, a cyano group, a phenyl group, a biphenyl group, a pyridinyl group, a pyrimidinyl group, a pyridazinyl group, a pyrazinyl group, a triazinyl group, or any combination thereof; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

For example, in one or more embodiments, the third monomer may include trimethylolpropane triacrylate.

According to one or more embodiments, the third monomer may further include a monomer having two functional groups in addition to a monomer having three functional groups.

According to one or more embodiments, the third monomer may further include a monomer represented by Formula 3-2:

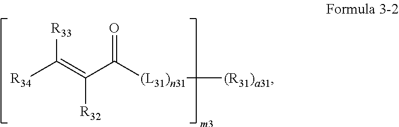

wherein, in Formula 3-2,
L₃₁, n31, R₃₁ to R₃₄, and a31 may each be the same as described herein, and
m3 may be 2.

For example, in one or more embodiments, the third monomer may further include 1,6-hexanediol diacrylate.

### Light-Shielding Material

According to one or more embodiments, the composition may include a light-shielding material. The composition may include the light-shielding material, thereby having a function of preventing or reducing light leakage, for example, a function of preventing or reducing light from being emitted from a display panel.

According to one or more embodiments, the light-shielding material may include carbon black and an inorganic material.

According to one or more embodiments, the inorganic material may be an inorganic oxide.

According to one or more embodiments, the inorganic material may include at least one of Al₂O₃, CaCO₃, or TiO₂.

According to one or more embodiments, a content (e.g., amount) of the first monomer may be in a range of about 50 parts by weight to about 60 parts by weight, based on 100 parts by weight of the total weight of the composition.

According to one or more embodiments, the first monomer may include a first-first monomer and a first-second monomer,
a content (e.g., amount) of the first-first monomer may be in a range of about 30 parts by weight to about 40 parts by weight, based on 100 parts by weight of the total weight of the composition, and
a content (e.g., amount) of the first-second monomer may be in a range of about 5 parts by weight to about 25 parts by weight, based on 100 parts by weight of the total weight of the composition.

According to one or more embodiments, the composition may include a second monomer, and a content (e.g., amount) of the second monomer may be in a range of about 20 parts by weight to about 40 parts by weight, based on 100 parts by weight of the total weight of the composition.

According to one or more embodiments, the composition may include a third monomer, and a content (e.g., amount) of the third monomer may be in a range of about 3 parts by weight to about 12 parts by weight, based on 100 parts by weight of the total weight of the composition.

According to one or more embodiments, the composition may include a light-shielding material, and the light-shielding material may be present in an amount of more than 0 parts by weight and less than or equal to 10 parts by weight, based on 100 parts by weight of the total weight of the composition.

According to one or more embodiments, the light-shielding material may include carbon black and an inorganic material, and the carbon black may be present in an amount of more than 0 parts by weight and less than or equal to 5 parts by weight, based on 100 parts by weight of the total weight of the composition.

The inorganic material may be present in an amount of more than 0 parts by weight and less than or equal to 5 parts by weight, based on 100 parts by weight of the total weight of the composition.

According to one or more embodiments, the composition may further include an alcohol monomer.

According to one or more embodiments, an initiator may be added to the composition to form a cured product of the composition.

According to one or more embodiments, the initiator may include a visible light initiator. A visible light initiator may refer to a compound that is decomposed by visible light and generates radicals that initiate a polymerization reaction of a monomer.

According to one or more embodiments, the initiator may further include an ultraviolet initiator. An ultraviolet initiator may refer to a compound that is decomposed by ultraviolet light and generates radicals that initiate a polymerization reaction of a monomer.

For example, the initiator may refer to a compound that is decomposed by ultraviolet light or visible light or heat or a chemical and generates radicals that initiate a polymerization reaction of a monomer.

### Display Apparatus Including the Cured Product of the Composition

The spatially relative terms “below,” “beneath,” “lower,” “above,” “upper,” and/or the like, may be used herein to facilitate describing the relationship between one element or component and another element or component, as illustrated in the drawings. It should be understood that spatially relative terms are intended to encompass different directions of a device in use or operation in addition to the direction illustrated in the drawings. In one or more embodiments, if (e.g., when) a device illustrated in the drawings is turned over (e.g., turned upside down), an element described as being “below” or “beneath” another element may be placed “above” the another element. Accordingly, the term “below” may include both (e.g., simultaneously) the downward direction and the upward direction. Furthermore, the device may be oriented in other directions, and thus spatially relative terms may be interpreted according to the orientation.

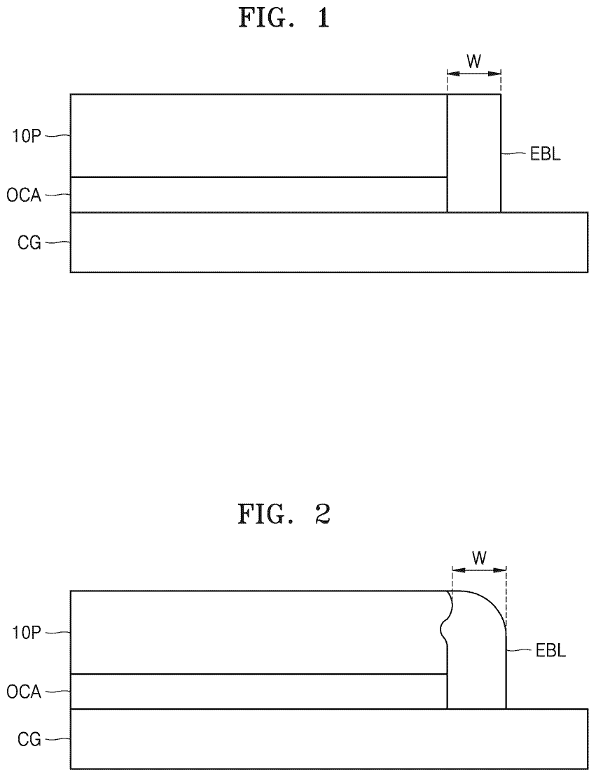

Hereinafter, a display apparatus according to one or more embodiments of the disclosure will be described in more detail with reference to FIG. 1 and FIG. 2.

A display apparatus according to one or more embodiments of the disclosure may include: a display panel 10P including a light-emitting device; and a barrier layer EBL in contact with a side of the display panel 10P, wherein the barrier layer EBL may include a cured product of a composition according to one or more embodiments of the disclosure.

According to one or more embodiments, the barrier layer EBL may be in contact with a portion of an upper part of the display panel 10P including the side of the display panel 10P. The expression “upper part of the display panel 10P” is based on the orientation of FIG. 1, for example, if (e.g., when) the device illustrated in FIG. 1 is turned over (e.g., turned upside down), the barrier layer EBL may come into contact with a portion of a lower part of the display panel 10P.

According to one or more embodiments, a width w of the barrier layer EBL may be 300 micrometers (μm) or less.

According to one or more embodiments, the width w of the barrier layer EBL may be 10 μm or more.

Herein, the width w of the barrier layer EBL may be a length of the barrier layer measured in a horizontal direction extending from an interface where the display panel 10P and the barrier layer EBL come into contact with each other. In other words, the width w of the barrier layer EBL may be a length of the barrier layer measured from a first end of the barrier layer EBL contacting with the display panel 10P to and a second end of the barrier layer EBL opposite to the first end. As shown in FIG. 2, if (e.g., when) the interface where the display panel 10P and the barrier layer EBL come into contact each other is not uniform, the width w of the barrier layer EBL may be a length of the barrier layer measured in the horizontal direction extending from an end of the display panel 10P that protrudes (juttingly comes) into contact with the barrier layer EBL, i.e., from the interface closest to an end of the barrier layer EBL that is opposite to the interface. For example, the width w of the barrier layer EBL is the horizontal length from where it contacts the display panel 10P to the opposite end. For example, if the contact interface is uneven, the width w is measured from the point where the display panel 10P protrudes into the barrier layer EBL.

According to one or more embodiments, the barrier layer EBL may be a single layer including a cured product of the composition according to the disclosure. The display apparatus according to the disclosure may concurrently (e.g., simultaneously) have a function of preventing or reducing light leakage and a barrier function against external substances by using a single layer including the cured product of the composition according to the disclosure as a barrier layer.

According to one or more embodiments, the display apparatus may include: a display panel 10P including a light-emitting device; a cover glass CG; and an adhesive layer OCA arranged between the display panel 10P and the cover glass CG, and may include a barrier layer EBL in contact with a side of the display panel 10P and a side of the adhesive layer OCA, wherein the barrier layer EBL may include the cured product of the composition according to the disclosure. Light emitted from the display panel 10P of the display apparatus may be emitted through the cover glass CG.

In one or more embodiments, one or more suitable types (kinds) of layers may be further arranged as needed between the display panel 10P and the adhesive layer OCA and between the adhesive layer OCA and the cover glass CG.

### Definition of Terms

The term “C₃-C₆₀ carbocyclic group” as used herein refers to a cyclic group including (e.g., consisting of) carbon atoms as the only ring-forming atoms and having 3 to 60 carbon atoms, and the term “C₁-C₆₀ heterocyclic group” as used herein refers to a cyclic group having 1 to 60 carbon atoms and further including, in addition to a carbon atom, a heteroatom as a ring-forming atom. The C₃-C₆₀ carbocyclic group and the C₁-C₆₀ heterocyclic group may each be a monocyclic group including (e.g., consisting of) one (e.g., exactly one) ring or a polycyclic group in which two or more rings are condensed with each other. In one or more embodiments, the number of ring-forming atoms of the C₁-C₆₀ heterocyclic group may be 3 to 61.

The “cyclic group” as used herein may include both (e.g., simultaneously) the C₃-C₆₀ carbocyclic group and the C₁-C₆₀ heterocyclic group.

The C₃-C₆₀ carbocyclic group may be i) Group T1 or ii) a condensed cyclic group in which two or more of Group T1 are condensed with each other (for example, a cyclopentadiene group, an adamantane group, a norbornane group, a benzene group, a pentalene group, a naphthalene group, an azulene group, an indacene group, an acenaphthylene group, a phenalene group, a phenanthrene group, an anthracene group, a fluoranthene group, a triphenylene group, a pyrene group, a chrysene group, a perylene group, a pentaphene group, a heptalene group, a naphthacene group, a picene group, a hexacene group, a pentacene group, a rubicene group, a coronene group, an ovalene group, an indene group, a fluorene group, a spiro-bifluorene group, a benzofluorene group, an indenophenanthrene group, or an indenoanthracene group),
the C₁-C₆₀ heterocyclic group may be i) Group T2, ii) a condensed cyclic group in which two or more of Group T2 are condensed with each other, or iii) a condensed cyclic group in which one or more of Group T2 and one or more of Group T1 are condensed with each other (for example, a pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonaphthothiophene group, a benzonaphthosilole group, a benzofurodibenzofuran group, a benzofurodibenzothiophene group, a benzothienodibenzothiophene group, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, an azadibenzofuran group, and/or the like.),

Group T1 may be a cyclopropane group, a cyclobutane group, a cyclopentane group, a cyclohexane group, a cycloheptane group, a cyclooctane group, a cyclobutene group, a cyclopentene group, a cyclopentadiene group, a cyclohexene group, a cyclohexadiene group, a cycloheptene group, an adamantane group, a norbornane (or bicyclo[2.2.1]heptane) group, a norbornene group, a bicyclo[1.1.1]pentane group, a bicyclo[2.1.1]hexane group, a bicyclo[2.2.2]octane group, or a benzene group,

Group T2 may be a furan group, a thiophene group, a 1H-pyrrole group, a silole group, a borole group, a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, a tetrazine group, a pyrrolidine group, an imidazolidine group, a dihydropyrrole group, a piperidine group, a tetrahydropyridine group, a dihydropyridine group, a hexahydropyrimidine group, a tetrahydropyrimidine group, a dihydropyrimidine group, a piperazine group, a tetrahydropyrazine group, a dihydropyrazine group, a tetrahydropyridazine group, or a dihydropyridazine group,

Group T3 may be a furan group, a thiophene group, a 1H-pyrrole group, a silole group, or a borole group, and

Group T4 may be a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, or a tetrazine group.

The terms “cyclic group”, “C₃-C₆₀ carbocyclic group”, “C₁-C₆₀ heterocyclic group”, “π electron-rich C₃-C₆₀ cyclic group”, or “π electron-deficient nitrogen-containing C₁-C₆₀ cyclic group” as used herein may refer to a group condensed to any cyclic group, a monovalent group, or a polyvalent group (for example, a divalent group, a trivalent group, a tetravalent group, and/or the like) according to the structure of a formula for which the corresponding term is used. In one or more embodiments, the “benzene group” may be a benzo group, a phenyl group, a phenylene group, and/or the like, which may be easily understood by those of ordinary skill in the art according to the structure of a formula including the “benzene group.”

For example, non-limiting examples of a monovalent C₃-C₆₀ carbocyclic group and a monovalent C₁-C₆₀ heterocyclic group may include a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₁-C₆₀ heteroaryl group, a monovalent non-aromatic condensed polycyclic group, and a monovalent non-aromatic condensed heteropolycyclic group, and non-limiting examples of a divalent C₃-C₆₀ carbocyclic group and a divalent C₁-C₆₀ heterocyclic group may include a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a C₁-C₆₀ heteroarylene group, a divalent non-aromatic condensed polycyclic group, and a divalent non-aromatic condensed heteropolycyclic group.

The term “C₁-C₆₀ alkyl group” as used herein refers to a linear or branched aliphatic hydrocarbon monovalent group that has 1 to 60 carbon atoms, and non-limiting examples thereof may include a methyl group, an ethyl group, an n-propyl group, an isopropyl group, an n-butyl group, a sec-butyl group, an isobutyl group, a tert-butyl group, an n-pentyl group, a tert-pentyl group, a neopentyl group, an isopentyl group, a sec-pentyl group, a 3-pentyl group, a sec-isopentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and/or the like. The term “C₁-C₆₀ alkylene group” as used herein refers to a divalent group having substantially the same structure as the C₁-C₆₀ alkyl group.

The term “C₂-C₆₀ alkenyl group” as used herein refers to a monovalent hydrocarbon group including one or more carbon-carbon double bond in the middle or at the terminus of a C₂-C₆₀ alkyl group, and non-limiting examples thereof may include an ethenyl group, a propenyl group, a butenyl group, and/or the like. The term “C₂-C₆₀ alkenylene group” as used herein refers to a divalent group having substantially the same structure as the C₂-C₆₀ alkenyl group.

The term “C₂-C₆₀ alkynyl group” as used herein refers to a monovalent hydrocarbon group having one or more carbon-carbon triple bond in the middle or at the terminus of a C₂-C₆₀ alkyl group, and non-limiting examples thereof may include an ethynyl group, a propynyl group, and/or the like. The term “C₂-C₆₀ alkynylene group” as used herein refers to a divalent group having substantially the same structure as the C₂-C₆₀ alkynyl group.

The term “C₁-C₆₀ alkoxy group” as used herein refers to a monovalent group represented by —OA₁₀₁ (wherein A₁₀₁ is a C₁-C₆₀ alkyl group), and non-limiting examples thereof may include a methoxy group, an ethoxy group, an isopropyloxy group, and/or the like.

The term “C₃-C₁₀ cycloalkyl group” as used herein refers to a monovalent saturated hydrocarbon cyclic group having 3 to 10 carbon atoms, and non-limiting examples thereof may include a cyclopropyl group, a cyclobutyl group, a cyclopentyl group, a cyclohexyl group, a cycloheptyl group, a cyclooctyl group, an adamantanyl group, a norbornyl group (or bicyclo[2.2.1]heptyl group), a bicyclo[1.1.1]pentyl group, a bicyclo[2.1.1]hexyl group, a bicyclo[2.2.2]octyl group, and/or the like. The term “C₃-C₁₀ cycloalkylene group” as used herein refers to a divalent group having substantially the same structure as the C₃-C₁₀ cycloalkyl group.

The term “C₁-C₁₀ heterocycloalkyl group” as used herein refers to a monovalent cyclic group having 1 to 10 carbon atoms and further including, in addition to the carbon atoms, at least one heteroatom as a ring-forming atom, and non-limiting examples thereof may include a 1,2,3,4-oxatriazolidinyl group, a tetrahydrofuranyl group, a tetrahydrothiophenyl group, and/or the like. The term “C₁-C₁₀ heterocycloalkylene group” as used herein refers to a divalent group having substantially the same structure as the C₁-C₁₀ heterocycloalkyl group.

The term “C₃-C₁₀ cycloalkenyl group” as used herein refers to a monovalent cyclic group having 3 to 10 carbon atoms and at least one carbon-carbon double bond in the ring thereof and no aromaticity, and non-limiting examples thereof may include a cyclopentenyl group, a cyclohexenyl group, a cycloheptenyl group, and/or the like. The term “C₃-C₁₀ cycloalkenylene group” as used herein refers to a divalent group having substantially the same structure as the C₃-C₁₀ cycloalkenyl group.

The term “C₁-C₁₀ heterocycloalkenyl group” as used herein refers to a monovalent cyclic group having 1 to 10 carbon atoms, further including, in addition to the carbon atoms, at least one heteroatom as a ring-forming atom, and having at least one double bond in the ring thereof. Non-limiting examples of the C1-C10 heterocycloalkenyl group may include a 4,5-dihydro-1,2,3,4-oxatriazolyl group, a 2,3-dihydrofuranyl group, a 2,3-dihydrothiophenyl group, and/or the like. The term “C₁-C₁₀ heterocycloalkenylene group” as used herein refers to a divalent group having substantially the same structure as the C₁-C₁₀ heterocycloalkenyl group.

The term “C₆-C₆₀ aryl group” as used herein refers to a monovalent group having a carbocyclic aromatic system of 6 to 60 carbon atoms, and the term “C₆-C₆₀ arylene group” as used herein refers to a divalent group having a carbocyclic aromatic system of 6 to 60 carbon atoms. Non-limiting examples of the C₆-C₆₀ aryl group may include a phenyl group, a pentalenyl group, a naphthyl group, an azulenyl group, an indacenyl group, an acenaphthyl group, a phenalenyl group, a phenanthrenyl group, an anthracenyl group, a fluoranthenyl group, a triphenylenyl group, a pyrenyl group, a chrysenyl group, a perylenyl group, a pentaphenyl group, a heptalenyl group, a naphthacenyl group, a picenyl group, a hexacenyl group, a pentacenyl group, a rubicenyl group, a coronenyl group, an ovalenyl group, and/or the like. When the C₆-C₆₀ aryl group and the C₆-C₆₀ arylene group each include two or more rings, the two or more rings may be condensed with each other.

The term “C₁-C₆₀ heteroaryl group” as used herein refers to a monovalent group having a heterocyclic aromatic system that has 1 to 60 carbon atoms and further includes, in addition to the carbon atoms, at least one heteroatom as a ring-forming atom. The term “C₁-C₆₀ heteroarylene group” as used herein refers to a divalent group having a heterocyclic aromatic system that has 1 to 60 carbon atoms and further includes, in addition to the carbon atoms, at least one heteroatom as a ring-forming atom. Non-limiting examples of the C₁-C₆₀ heteroaryl group may include a pyridinyl group, a pyrimidinyl group, a pyrazinyl group, a pyridazinyl group, a triazinyl group, a quinolinyl group, a benzoquinolinyl group, an isoquinolinyl group, a benzoisoquinolinyl group, a quinoxalinyl group, a benzoquinoxalinyl group, a quinazolinyl group, a benzoquinazolinyl group, a cinnolinyl group, a phenanthrolinyl group, a phthalazinyl group, a naphthyridinyl group, and/or the like. When the C₁-C₆₀ heteroaryl group and the C₁-C₆₀ heteroarylene group each include two or more rings, the two or more rings may be condensed with each other.

The term “monovalent non-aromatic condensed polycyclic group” as used herein refers to a monovalent group (for example, having 8 to 60 carbon atoms) having two or more rings condensed to each other, only carbon atoms as ring-forming atoms, and no aromaticity in the entire molecular structure when considered as a whole. Non-limiting examples of the monovalent non-aromatic condensed polycyclic group may include an indenyl group, a fluorenyl group, a spiro-bifluorenyl group, a benzofluorenyl group, an indenophenanthrenyl group, an indeno anthracenyl group, and/or the like. The term “divalent non-aromatic condensed polycyclic group” as used herein refers to a divalent group having substantially the same structure as the monovalent non-aromatic condensed polycyclic group.

The term “monovalent non-aromatic condensed heteropolycyclic group” as used herein refers to a monovalent group (for example, having 1 to 60 carbon atoms) having two or more rings condensed to each other, further including, in addition to carbon atoms, at least one heteroatom, as ring-forming atoms, and having no aromaticity in its entire molecular structure when considered as a whole. Non-limiting examples of the monovalent non-aromatic condensed heteropolycyclic group may include a pyrrolyl group, a thiophenyl group, a furanyl group, an indolyl group, a benzoindolyl group, a naphthoindolyl group, an isoindolyl group, a benzoisoindolyl group, a naphthoisoindolyl group, a benzosilolyl group, a benzothiophenyl group, a benzofuranyl group, a carbazolyl group, a dibenzosilolyl group, a dibenzothiophenyl group, a dibenzofuranyl group, an azacarbazolyl group, an azafluorenyl group, an azadibenzosilolyl group, an azadibenzothiophenyl group, an azadibenzofuranyl group, a pyrazolyl group, an imidazolyl group, a triazolyl group, a tetrazolyl group, an oxazolyl group, an isoxazolyl group, a thiazolyl group, an isothiazolyl group, an oxadiazolyl group, a thiadiazolyl group, a benzopyrazolyl group, a benzimidazolyl group, a benzoxazolyl group, a benzothiazolyl group, a benzoxadiazolyl group, a benzothiadiazolyl group, an imidazopyridinyl group, an imidazopyrimidinyl group, an imidazotriazinyl group, an imidazopyrazinyl group, an imidazopyridazinyl group, an indenocarbazolyl group, an indolocarbazolyl group, a benzofurocarbazolyl group, a benzothienocarbazolyl group, a benzosilolocarbazolyl group, a benzoindolocarbazolyl group, a benzocarbazolyl group, a benzonaphthofuranyl group, a benzonaphthothiophenyl group, a benzonaphthosilolyl group, a benzofurodibenzofuranyl group, a benzofurodibenzothiophenyl group, a benzothienodibenzothiophenyl group, and/or the like. The term “divalent non-aromatic condensed heteropolycyclic group” as used herein refers to a divalent group having substantially the same structure as the monovalent non-aromatic condensed heteropolycyclic group.

The term “C₆-C₆₀ aryloxy group” as used herein refers to —OA₁₀₂ (wherein A₁₀₂ is a C₆-C₆₀ aryl group), and the term “C₆-C₆₀ arylthio group” as used herein refers to —SA₁₀₃ (wherein A₁₀₃ is a C₆-C₆₀ aryl group).

The term “C₇-C₆₀ arylalkyl group” as used herein refers to —A₁₀₄A₁₀₅ (wherein A₁₀₄ is a C₁-C₅₄ alkylene group, and A₁₀₅ is a C₆-C₅₉ aryl group), and the term “C₂-C₆₀ heteroarylalkyl group” as used herein refers to —A₁₀₆A₁₀₇ (wherein A₁₀₆ is a C₁-C₅₉ alkylene group, and A₁₀₇ is a C₁-C₅₉ heteroaryl group).

The term “heteroatom” as used herein refers to any atom other than a carbon atom and a hydrogen atom. Non-limiting examples of the heteroatom may include B, O, S, N, P, Si, B, Ge, Se, and any combination thereof.

The term “biphenyl group” as used herein refers to “a phenyl group substituted with a phenyl group.” For example, the “biphenyl group” may be “a substituted phenyl group” having a “C₆-C₆₀ aryl group” as a substituent.

The term “terphenyl group” as used herein refers to “a phenyl group substituted with a biphenyl group.” The “terphenyl group” may be “a substituted phenyl group” having a “C₆-C₆₀ aryl group substituted with a C₆-C₆₀ aryl group” as a substituent.

Depending on context, in the present disclosure, an organic group may refer to or be a monovalent or a polyvalent group (e.g., divalent, trivalent, tetravalent, etc.) per, e.g., the structure of a formula in connection with which of the terms are utilized.

* and *′ as used herein, unless defined otherwise, each refer to a binding site to a neighboring atom in a corresponding formula or moiety.

Hereinafter, a composition and a display apparatus according to one or more embodiments will be described in more detail with reference to the following Examples.

### EXAMPLES

### Preparation of Comparative Compositions 1 to 3 and Compositions 1 and 2

Using the compounds described in Table 1, Comparative Compositions 1 to 3 and Compositions 1 and 2 were prepared respectively according to the composition ratios described in Table 2.

TABLE 1

| Compound | Cas No. | Composition | |
|---|---|---|---|
| 1-1 | 4098-71-9 | Isophorone diisocyanate | 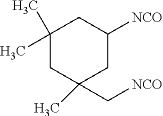 |
| 1-2 | 5124-30-1 | Dicyclohexylmethane 4,4′-Diisocyanate | 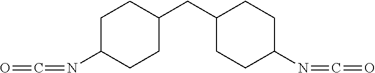 [SMILES: O=C=NC1CCC(CC2CCC(N=C=O)CC2)CC1] |
| 1-3 | 822-06-0 | Hexamethylene Diisocyanate | 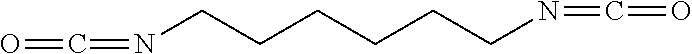 [SMILES: O=C=NCCCCCCN=C=O] |
| 2-1 | 2680-03-7 | N,N-Dimethylacrylamide | 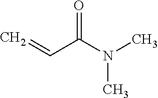 |
| 2-2 | 5888-33-5 | Isobornyl acrylate | 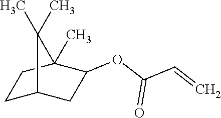 |
| 2-3 | 868-77-9 | 2-Hydroxyethyl methacrylate | 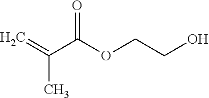 |
| 2-4 | 2156-97-0 | Lauryl acrylate | 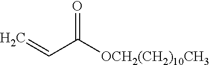 |
| 3-1 | 13048-33-4 | 1,6-Hexanediol diacrylate | 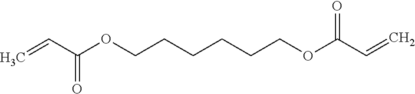 [SMILES: C=CC(=O)OCCCCCCOC(=O)C=C] |
| 3-2 | 15625-89-5 | Trimethylolpropane triacrylate | 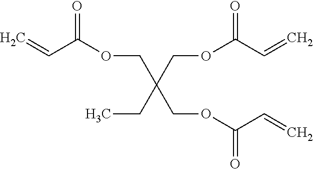 [SMILES: C=CC(=O)OCC(CC)(COC(=O)C=C)COC(=O)C=C] |
| 4-1 | — | Carbon Black | — |
| 4-2 | — | Al₂O₃ | — |
| 4-3 | — | CaCO₃, TiO₂ | — |

TABLE 2

| | Compar- | | | Compar- | Compar- |
|---|---|---|---|---|---|
| | ative | | | ative | ative |
| | Composi- | Composi- | Composi- | Composi- | Composi- |
| | tion 1 | tion 1 | tion 2 | tion 2 | tion 3 |
| 1-1 | 35 | 35 | 35 | 25 | 25 |
| 1-2 | — | 10 | 20 | 20 | 10 |
| 1-3 | 20 | 10 | — | 10 | 20 |
| 2-1 | 7.5 | 10 | 10 | 10 | — |
| 2-2 | 7.5 | 10 | 10 | 5 | 10 |
| 2-3 | — | — | 10 | 5 | — |
| 2-4 | 20 | 10 | — | 10 | 30 |
| 3-1 | 5 | 5 | — | 10 | — |
| 3-2 | — | 5 | 10 | — | — |
| 4-1 | 5 | 3 | 3 | 4 | 4 |
| 4-2 | — | 2 | — | 1 | — |
| 4-3 | — | — | 2 | — | 1 |
| Total | 100 | 100 | 100 | 100 | 100 |

### Evaluation Example 1. Evaluation of Properties of Cured Products of Comparative Compositions 1 to 3 and Compositions 1 and 2

Comparative Compositions 1 to 3 and Compositions 1 and 2 were each applied onto the edge of a display panel by using a dispenser device, and then cured by irradiating with energy of 3000 to 5000 mJ/cm² at a wavelength of 365 nm with a light-emitting diode (LED) curing device. The physical properties in Tables 3 and 4 were measured by using the evaluation methods described herein and the results are shown in Tables 3 and 4.
1) Viscosity: Measured by using a Brookfield viscometer.
2) Thixotropic Index (TI): Obtained by measuring a viscosity at 2 rpm and a viscosity at 20 rpm by using a Brookfield viscometer and calculating a ratio thereof.
3) Optical Density (OD): Measured with an OD Meter in a wavelength range of 380 nm to 760 nm.
4) Free Volume Radius and Fractional Free Volume: Obtained by measuring an annihilation lifetime of a positron by using positron annihilation lifetime spectroscopy (PALS) equipment and calculating a free volume of a polymer using Tao-Eldrup positron bubble model. The specimen used for the measurement had a size of 3 cm×3 cm and a thickness of 1 mm or more.

$${τ}_{3} = 0.5 \times {[ 1 - \frac{R}{R + Δ R} + \frac{1}{2 π} Sin ( \frac{2 π R}{R + Δ R} ) ]}^{- 1}$$

$${τ}_{3} : ortho - positronium lifetime$$

$$R : cavity radius$$

$${R}_{0} : R + Δ R$$

$$Δ R : empirical parameter ( 1.66 Å )$$

5) Average molecular weight between crosslinks (Mc): Obtained by measuring G (storage modulus) using DMA, measuring p (density) of a sample after curing by using a densimeter, and calculating Mc by entering these values into Equation 10:

### Equation 10

6) Water vapor transmission rate (WVTR): Measured by using Mocon equipment at 39° C. and RH 100% on a specimen having a size of 5 cm×5 cm×100 μm.
7) Gel Fraction: Obtained by drying a cured specimen having a size of 1 μm×1 μm×100 μm at 80° C. for 30 minutes, leaving the specimen in acetone, toluene, or butyl-acetate for 3 days, removing the solvent from the surface of the specimen, drying the specimen at 80° C. for 30 minutes, measuring the weight difference before and after immersion, and calculating a ratio thereof.

TABLE 3

| | Viscosity | | | Free Volume | Fractional Free |
|---|---|---|---|---|---|
| | (cPs) | TI | OD | Radius (Å) | Volume (%) |
| Comparative | 4500 | 1.2 | 2.2 | 3.17 | 3.04 |
| Composition 1 | | | | | |
| Composition 1 | 2500 | 1.6 | 2.3 | 2.85 | 2.00 |
| Composition 2 | 5000 | 2.4 | 2.4 | 2.46 | 1.85 |
| Comparative | 3700 | 1.5 | 2.1 | 3.05 | 3.08 |
| Composition 2 | | | | | |
| Comparative | 7200 | 1.8 | 2.2 | 3.34 | 5.17 |
| Composition 3 | | | | | |

TABLE 4

| | | | Gel Fraction (%) | | |
|---|---|---|---|---|---|
| | Mc | WVTR | | | Butyl |
| | (g/mol) | (g/m²*day) | Acetone | Toluene | Acetate |
| Comparative | 1.225*10⁵ | 605 | 57.4 | 63.6 | 59.1 |
| Composition 1 | | | | | |
| Composition 1 | 5.024*10⁴ | 379 | 93.3 | 92.9 | 92.6 |
| Composition 2 | 9.724*10³ | 157 | 97.0 | 95.6 | 95.6 |
| Comparative | 1.021*10⁵ | 573 | 61.1 | 62.7 | 60.8 |
| Composition 2 | | | | | |
| Comparative | 8.465*10⁶ | 791 | 55.7 | 54.6 | 57.5 |
| Composition 3 | | | | | |

### Evaluation Example 2. Evaluation of Barrier Properties of Cured Products of Comparative Composition 1 and Compositions 1 and 2

Comparative Composition 1 or Composition 1 or Composition 2 was applied onto the edge of a panel by using a dispenser, and then cured with 365 nm UV to form a barrier layer including a cured product of the applied composition, after which one of chemicals (Sanitizer, isopropyl alcohol (IPA), Sunscreen, and Sebum) was applied onto the barrier layer and left for 48 hours. Subsequently, the applied chemical was removed, and then an unbiased highly accelerated temperature and humidity stress test (uHAST) (60° C., 93% humidity, 72 hours) was performed, and the panel was observed under a microscope.

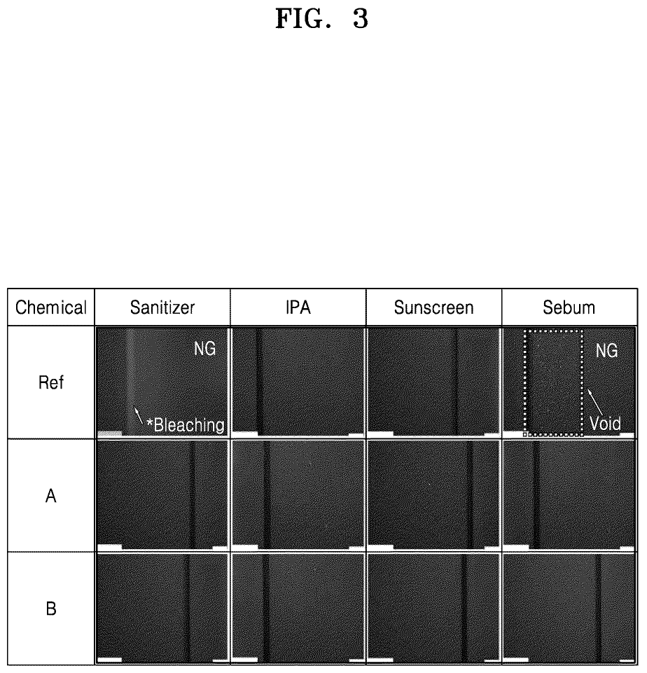

Referring to FIG. 3, it was observed from the results that when Compositions 1 (A in FIG. 3) and 2 (B in FIG. 3) were used as a composition for forming a barrier layer, no panel defects occurred for any evaluated chemicals, and when Comparative Composition 1 (Ref in FIG. 3) was used, panel defects occurred for Sanitizer and Sebum.

### Evaluation Example 3. Measurement of Width of Barrier Layer

Comparative Composition 1 or Composition 1 or Composition 2 was applied onto the edge of a panel by using a dispenser, and then cured with 365 nm UV to form a barrier layer including cured products of the compositions, after which a width of the formed barrier layer was measured by using a microscope.

TABLE 5

| | Width of barrier layer (μm) |
|---|---|
| Comparative Composition 1 | 300~400 |
| Composition 1 | 200~300 |
| Composition 2 | 200~250 |

Referring to Table 5, it can be confirmed that if (e.g., when) a barrier layer is formed by using Composition 1 or Composition 2, the width of the barrier layer is 300 μm or less.

By using the composition according to one or more embodiments of the disclosure, a display apparatus including a barrier layer composed of the cured product of the composition on a side of a display panel may be implemented, the barrier layer with (having) both (e.g., simultaneously) a function of preventing or reducing light leakage and a barrier function against external substances such as chemicals. For example, the display apparatus may be implemented with the barrier layer composed of the cured product of the composition (according to one or more embodiments) on the side of the display panel. This barrier layer simultaneously functions to prevent or reduce light leakage and to protect against external substances such as chemicals.

According to one or more embodiments of the present disclosure, the display apparatus may be applied to one or more electronic devices. The electronic device may include one or more selected from among televisions, monitors, outside billboards, personal computers, laptop computers, personal digital terminals, display devices for automobiles, game consoles, portable electronic devices, Internet of Things devices, cameras, mobile phones, smartphones, tablet computers, mobile communication terminals, electronic notebooks, electronic books, portable multimedia players, navigation devices, ultra-mobile personal computers, smartwatches, watch phones, and head-mounted display devices.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

The display apparatus, the display panel, the light-emitting element, the manufacturing apparatus thereof, or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

It should be understood that embodiments described herein should be considered in a descriptive sense only and not for purposes of limitation. Descriptions of features or aspects within each embodiment should typically be considered as available for other similar features or aspects in one or more embodiments. While one or more embodiments have been described with reference to the drawings, it will be understood by those of ordinary skill in the art that one or more suitable changes in form and details may be made therein without departing from the spirit and scope as defined by the appended claims and equivalents thereof.

What is claimed is:

1. A composition, comprising:
a first monomer;
a second monomer;
a third monomer; and
a light-shielding material,
wherein,
the first monomer comprises at least one of an isocyanate monomer, an acrylate monomer, or a siloxane monomer,
the second monomer comprises at least one of an amide monomer or an acrylate monomer,
the third monomer comprises a monomer having three or more functional groups,
the first monomer, the second monomer, the third monomer, and the light-shielding material are different from one another,
a free volume radius of a cured product of the composition is 3.00 Å or less, and a fractional free volume of the cured product of the composition is 2.50% or less.

2. The composition of claim 1,
wherein an average molecular weight between crosslinks (Mc) of the cured product of the composition is 5.024×10⁴ g/mol or less.

3. The composition of claim 1,
wherein a gel fraction value measured for a solvent selected from among acetone, toluene, and butyl acetate, for the cured product of the composition, is 90.0% or more.

4. The composition of claim 1,
wherein a thixotropic index (TI) value of the cured product of the composition is 1.6 or more.

5. The composition of claim 1,
wherein, when a thickness of the cured product of the composition is 30 μm, then an optical density (OD) value of the cured product of the composition is 2 or more with respect to light having a wavelength of about 380 nm to about 760 nm.

6. The composition of claim 1,
wherein a viscosity of the cured product of the composition is 1,000 cPs to 20,000 cPs at 25° C.

7. The composition of claim 1,
wherein the first monomer comprises an isocyanate monomer.

8. The composition of claim 7,
wherein the isocyanate monomer comprises one or more saturated hydrocarbon rings.

9. The composition of claim 1,
wherein the first monomer comprises a compound represented by Formula 1-1 or Formula 1-2: 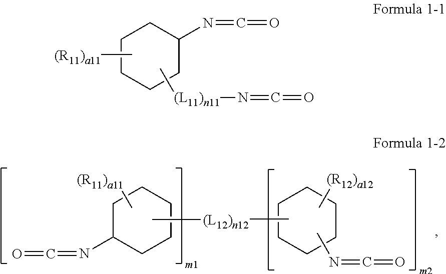
and
wherein, in Formulae 1-1 and 1-2,
R₁₁ and R₁₂ are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a11 and a12 are each independently an integer from 1 to 10,
L₁₁ and L₁₂ are each independently a single bond, a C₁-C₆₀ alkylene group unsubstituted or substituted with at least one R₁₀ₐ, a C₂-C₆₀ alkenylene group unsubstituted or substituted with at least one R₁₀ₐ, a C₂-C₆₀ alkynylene group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, or any combination thereof,
n11 and n12 are each independently an integer from 1 to 5,
m1 and m2 are each independently an integer from 1 to 3,
R₁₀ₐ is:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, or a C₆-C₆₀ arylthio group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, a cyano group, a phenyl group, a biphenyl group, a pyrindyl group, a pyrimidinyl group, a pyridazinyl group, a pyrazinyl group, a triazinyl group, or any combination thereof; or a C₃-C₆₀ carbocyclic group, a C₁-C₆₀ hertocyclic group, a C₇-C₆₀ arylalkyl group, or a C₂C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

10. The composition of claim 1,
wherein the second monomer comprises a compound represented by Formula 2: 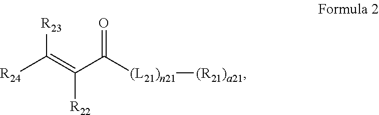
and
wherein, in Formula 2,
L₂₁ is a single bond, *—C(R₂ₐ)(R_{2b})—*′, *—C(R₂ₐ)═*′, *—C(R₂ₐ)═C(R_{2b})—*′, *—C(═O)—*′, *—C(═S)—*′, *—C≡C—*′, *—B(R₂ₐ)—*′, *—N(R₂ₐ)—*′, *—O—*′, *—P(R₂ₐ)—*′, *—Si(R₂ₐ)(R_{2b})—*′, *—P(═O)(R₂ₐ)—*′, *—S—*′, *—S(═O)—*′, *—S(═O)₂—*′, or *—Ge(R₂ₐ)(R_{2b})—*′, * and *′ each being a binding site with a neighboring atom,
R₂₁ to R₂₄, R₂ₐ, and R_{2b} are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a21 is an integer from 1 to 5,
n21 is an integer from 1 to 3,
R₁₀ₐ is:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, or a C₆-C₆₀ arylthio group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₈-C₆₀ carbocyclic group, a C₁-C₆₀ heterocyclic group, a C₆-C₆₀ aryloxy group, a C₆-C₆₀ arylthio group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, a cyano group, a phenyl group, a biphenyl group, a pyridinyl group, a pyrimidinyl group, a pyridazinyl group, a pyrazinyl group, a triazinyl group, or any combination thereof; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

11. The composition of claim 1,
wherein the third monomer comprises a compound represented by Formula 3-1: 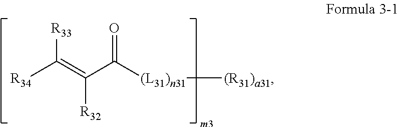
and
wherein, in Formula 3-1,
L₃₁ is a single bond, *—C(R₃ₐ)(R_{3b})—*′, *—C(R₃ₐ)═*′, *—C(R₃ₐ)═C(R_{3b})—*′, *—C(═O)—*′, *—C(═S)—*′, *—C≡C—*′, *—B(R₃ₐ)—*′, *—N(R₃ₐ)—*′, *—O—*′, *—P(R₃ₐ)—*′, *—Si(R₃ₐ)(R_{3b})—*′, *—P(═O)(R₃ₐ)—*′, *—S—*′, *—S(═O)—*′, *—S(═O)₂—*′, or *—Ge(R₃ₐ)(R_{3b})—*′, wherein * and *′ are each a binding site with a neighboring atom,
n31 is an integer from 1 to 3,
R₃₁ to R₃₄, R₃ₐ, and R_{3b} are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a31 is an integer from 1 to 5,
m3 is 3 or 4,
R₁₀ₐ is:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, or a C₆-C₆₀ arylthio group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₈-C₆₀ carbocyclic group, a C₁-C₆₀ heterocyclic group, a C₆-C₆₀ aryloxy group, a C₆-C₆₀ arylthio group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, a cyano group, a phenyl pyrazinyl group, a triazinyl group, or any combination thereof; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

12. The composition of claim 1,
wherein the light-shielding material comprises carbon black and an inorganic material.

13. The composition of claim 12,
wherein the inorganic material is an inorganic oxide.

14. The composition of claim 1,
wherein an amount of the first monomer is about 50 parts by weight to about 60 parts by weight, based on 100 parts by weight of the total weight of the composition.

15. The composition of claim 1,
wherein an amount of the second monomer is about 20 parts by weight to about 40 parts by weight, based on 100 parts by weight of the total weight of the composition.

16. The composition of claim 1,
wherein an amount of the third monomer is about 3 parts by weight to about 12 parts by weight, based on 100 parts by weight of the total weight of the composition.

17. The composition of claim 1,
wherein the light-shielding material is present in an amount of more than 0 parts by weight and less than or equal to 10 parts by weight, based on 100 parts by weight of the total weight of the composition.

18. A cured product, wherein the cured product is a cured product of the composition of claim 1 cured by UV curing and/or moisture curing.

19. A display apparatus, comprising:
a display panel comprising a light-emitting device; and
a barrier layer in contact with a side of the display panel,
wherein the barrier layer comprises a cured product of the composition of claim 1.

20. The display apparatus of claim 19,
wherein a width of the barrier layer is 300 μm or less.
